(19) United States
(12) Patent Application Publication
(10) Pub. No.: US 2013/0228352 A1
(43) Pub. Date: Sep. 5, 2013

(54) INTEGRATED HAND CULTIVATOR/SIFTER APPARATUS

(71) Applicant: David K. MARKS, Seattle, WA (US)

(72) Inventor: David K. MARKS, Seattle, WA (US)

(21) Appl. No.: 13/599,697

(22) Filed: Aug. 30, 2012

Related U.S. Application Data
(60) Provisional application No. 61/529,788, filed on Aug. 31, 2011.

(51) Int. Cl. A01B 1/20

(52) U.S. Cl. CPC A01B 1/20
USPC 172/375

(57) ABSTRACT

A hand-held integrated cultivator/sifting apparatus is provided herein.

### CROSS-REFERENCE TO RELATED APPLICATIONS

This application claims the benefit of priority to Provisional Application No. 61/529,788, filed Aug. 31, 2011, titled “INTEGRATED HAND CULTIVATOR/SIFTER APPARATUS,” filed under Attorney Docket No. MADA-2011002, and naming inventor David Marks. The above-cited application is incorporated herein by reference in its entirety, for all purposes.

### FIELD

The present disclosure relates to gardening implements, and more particularly, to a hand-held integrated soil cultivator/sifter.

### BACKGROUND

Hand-held cultivation devices are often used when preparing growing medium (e.g., soil, sand, clay, compost, and the like) for plants when engaging in farming, gardening, or other like activities. Regardless of whether the growing medium is located in a garden or in a container (e.g., a planter box or pot), a gardener may wish to prepare the growing medium for improved gardening results. Growing medium preparation includes loosening up packed soil and breaking up clumps of growing medium (i.e., in order to attain a finer, more interspersed growing medium texture); removing rocks and pebbles, and removing unwanted plant vegetation (e.g., grasses, weeds, roots, plant pests, and the like). Packed and clumpy growing medium may reduce total available pore space (i.e., lack of aeration), which may reduce the amount of oxygen available to the root systems of desirable plants. A lack of aeration in growing medium may also cause poor drainage, which may lead to a flooded gardening space. Excess rocks and pebbles in garden growing medium may lead to too much drainage of water, thereby reducing plant viability. Unwanted grasses, weeds, roots, and other types of unwanted materials can interfere with the use and management of desirable plants by competing with desirable plants for vital nutrients and water from the soil; crowding out or restricting light to the more desirable plants; and/or harboring and spreading of plant pathogens that infect and degrade the quality of desirable plants, thereby depriving the desirable plants from being their healthiest. In many cases, a gardener may want these unwanted materials to be removed from a desired gardening area in order to improve the growth potential of desirable plants.

Conventional methods of unpacking and removing unwanted material from soil can be laborious, time consuming, expensive, and/or dirty. For example, one conventional method involves digging into growing medium using a standard hand cultivator, breaking up packed and clumpy soil, and then individually picking out unwanted materials. Another conventional method generally involves a three step process. First, the gardener uses a standard hand cultivator to dig into the growing medium, thereby breaking up packed growing medium. The second step is to place the growing medium into a soil sifter, garden sieve, or other device that separates growing medium from unwanted material. The third step is to then to separate and disperse the growing medium by shaking the growing medium in the soil sifter/garden sieve over the desired gardening location.

These conventional methods may work in some circumstances, but have drawbacks in other circumstances. For one, while conventional methods are effective in open gardens, they may not be as practical in smaller garden containers such as flower pots or planters. For instance, when using a soil sifter/garden sieve, the soil sifter/garden sieve is often larger in diameter than a flower pot or planter box, resulting in growing medium dispersing not only in the container, but also on the surfaces adjacent to the container. Additionally, conventional methods may be unsatisfactory because of the added expense of purchasing three separate devices (i.e., hand cultivator, hand shovel, and soil sifter/garden sieve). Furthermore, the time spent performing each of these three steps when employing the three devices can be an additional burden. And although a typical hand cultivator is fairly inexpensive and can be purchased at most hardware or lawn and garden stores, soil sifters can be more costly and are not as widely available for purchase.

Moreover, many gardeners may wish to avoid getting their hands, fingers, and fingernails dirty when handling soil. Using the conventional methods and tools, it is often unavoidable to prevent hands, fingers, and fingernails from getting dirty. To avoid this outcome, many gardeners resort to wearing gloves or other protective clothing or coverings, which can be cumbersome and/or uncomfortable. In any event, while undertaking conventional methods of growing medium preparation, it is often necessary to remove gardening gloves in order to pick up the smaller pieces of unwanted materials, resulting in dirty hands, fingers, and/or fingernails. In many situations, the conventional methods cause gardeners to make the choice of having optimally prepared growing medium combined with dirty hands or having clean hands and less optimally prepared growing medium.

### BRIEF DESCRIPTION OF THE DRAWINGS

FIG. 1 shows a perspective view of an integrated cultivator/sifter apparatus with two tines laid out in a “Y” shaped configuration, in accordance with one embodiment.

FIG. 2 shows a perspective view of an integrated cultivator/sifter apparatus with three tines laid out in a modified “Y” shaped configuration, in accordance with one embodiment.

FIG. 3 shows a perspective view of an integrated cultivator/sifter apparatus with four tines laid out in a “square” configuration, in accordance with one embodiment.

FIGS. 4a and 4b shows top and side views of a multi-plane integrated cultivator/sifter apparatus with three tines laid out in a “square” configuration, in accordance with one embodiment.

FIG. 5 shows a perspective view of an integrated cultivator/sifter apparatus with three tines laid out in a basket mesh “Y” shaped configuration, in accordance with one embodiment.

FIG. 6 shows a bottom view of an integrated cultivator/sifter apparatus with three tines laid out in a basket mesh “Y” shaped configuration, in accordance with one embodiment.

FIG. 7 shows a back view of an integrated cultivator/sifter apparatus with three tines laid out in a basket mesh “Y” shaped configuration, in accordance with one embodiment.

FIG. 8 shows a front view of an integrated cultivator/sifter apparatus with three tines laid out in a basket mesh “Y” shaped configuration, in accordance with one embodiment.

FIG. 9 shows a side view of an integrated cultivator/sifter apparatus with three tines laid out in a basket mesh “Y” shaped configuration, in accordance with one embodiment.

FIG. 10 shows a top view of an integrated cultivator/sifter apparatus with three tines laid out in a basket mesh “Y” shaped configuration, in accordance with one embodiment.

### DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Unlike standard hand-held cultivators, embodiments of the Integrated Cultivator/Sifter apparatus described herein incorporate not only the tines of a conventional hand cultivator, but also an integrated soil sifter, thereby eliminating the need for the gardener to utilize two separate devices, while increasing time and workload efficiency when separating growing medium. Therefore, embodiments of the Integrated Cultivator/Sifter are better able to sift growing medium than standard hand-held cultivators.

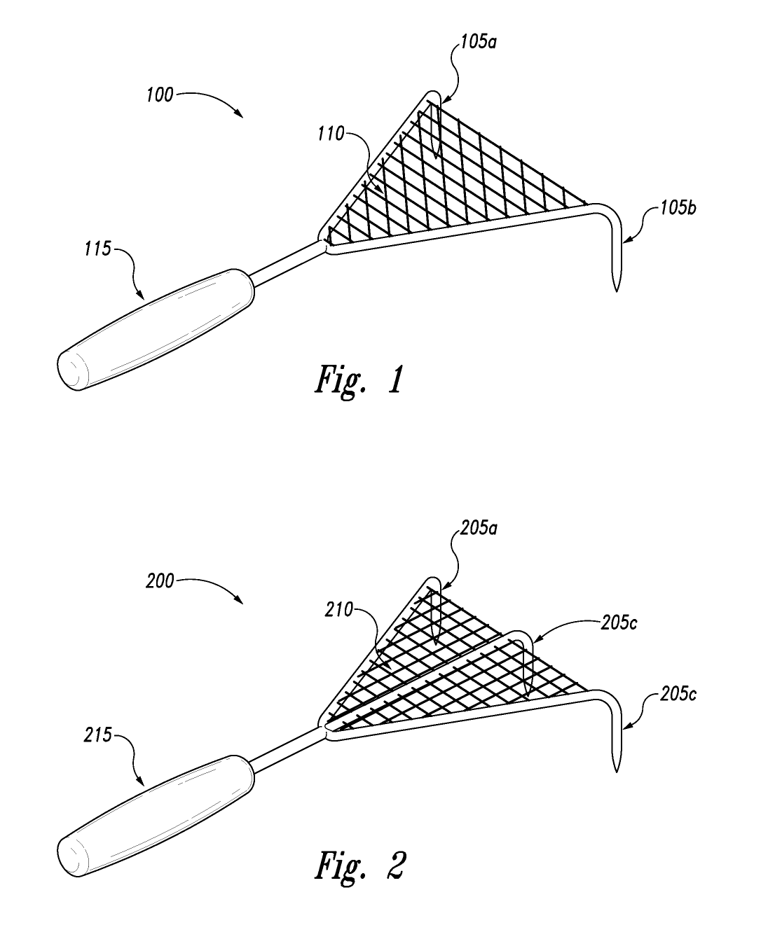

FIG. 1 shows a perspective view of Two-Tine Integrated Cultivator/Sifter 100 having two Tines 105a-b in a “Y” shape configuration, in accordance with one embodiment. Two-Tine Integrated Cultivator/Sifter 100 also comprises Integrated Perforated Screen 110 and Handle 115.

Tines 105a-b are configured to penetrate the growing medium when operated by a user. The illustrated embodiment shows two Tines 105a-b in a “Y” shape configuration; however, in various embodiments the number and configuration of tines used is variable and may include two or more tines configured in various shapes (See, e.g., FIGS. 2-4).

Integrated Perforated Screen 110 allows for the separation of desired growing medium from unwanted materials. In some embodiments, Integrated Perforated Side Panels (not shown in FIG. 1, but see FIG. 4b, discussed below) may also be used in combination with Integrated Perforated Screen 110 for ease of retaining scooped materials.

Handle 115 allows the apparatus to be held in one or two hands in order to manipulate Two-Tine Integrated Cultivator/Sifter 100 so as to perform growing medium preparation activities.

In operation, a user may hold Handle 115, penetrate the soil with Tines 105a-b, scoop up a portion of soil by turning the Two-Tine Integrated Cultivator/Sifter 100 so that Tines 105a-b face upwards, and then oscillate or otherwise agitate the Two-Tine Integrated Cultivator/Sifter 100 to separate out unwanted materials and spread the growing medium over a desired gardening area.

In various embodiments, the various component parts of Two-Tine Integrated Cultivator/Sifter 100 (i.e., Tines 105a-b, Handle 115, and Integrated Perforated Screen 110) may be manufactured out of various materials/fibers, including, but not limited to: metal, wood, plastic, and/or any other suitable materials, or any suitable combination thereof.

More specifically, in various embodiments, Tines 105a-b may be made of a material that is at least rigid enough to penetrate growing medium without unduly deforming, flexing, and/or otherwise losing its shape when being operated by a user. In various embodiments, Tines 105a-b are made of a material that is at least heat-resistant and/or water resistant enough to resist breaking down in conditions that are common to the gardening environment. In various embodiments, Tines 105a-b may be made of numerous materials that are combined in order to achieve the properties of a suitable material. For example, in various embodiments, suitable Tine materials may be manufactured out of various materials/fibers, including, but not limited to: metal, wood, plastic, and/or any other suitable materials, or any suitable combination thereof.

In various embodiments, Handle 115 is made at least in part of a material that is at least rigid enough to be gripped by a user without unduly deforming, flexing, and/or otherwise losing its shape when being operated by a user. However, in various embodiments, Handle 115 may also incorporate material that is at least flexible enough to produce physical comfort to a user when operating Two-Tine Integrated Cultivator/Sifter 100. Additionally, in various embodiments, Handle 115 is made of a material that is at least tacky enough to allow a user to maintain his/her grip when Two-Tine Integrated Cultivator/Sifter 100 is used in a wet environment. In various embodiments, Handle 115 is made of a suitable material that is at least heat-resistant and/or water resistant enough to resist breaking down in conditions that are common to the gardening environment. In various embodiments, Handle 115 may be made of numerous materials that are combined in order to achieve the desired properties of a suitable material. For example, in various embodiments, suitable Handle materials may be manufactured out of various materials/fibers, including, but not limited to: metal, wood, plastic, gels, foam, rubber, and/or any other suitable materials, or any suitable combination thereof.

In various embodiments, Integrated Perforated Screen 110 is made of a material that is at least rigid enough to separate growing medium from unwanted materials without unduly deforming, flexing, and/or otherwise losing its shape when Two-Tine Integrated Cultivator/Sifter 100 is being operated (e.g., oscillated or agitated) by a user. In various embodiments, Integrated Perforated Screen 110 is made of a material that is at least heat-resistant and/or water resistant enough to resist breaking down in conditions that are common to the gardening environment. In various embodiments, Integrated Perforated Screen 110 may be made of numerous materials that are combined in order to achieve the properties of a suitable material. For example, in various embodiments, suitable Integrated Perforated Screen materials may be manufactured out of various materials/fibers, including, but not limited to: metal, wood, plastic, and/or any other suitable materials, or any suitable combination thereof.

In various embodiments, Integrated Perforated Screen 110 comprises a barrier made up of openings that allow unpacked and/or de-clumped growing medium to pass through without letting at least some unwanted material pass through (referred to herein as a “mesh”) when Two-Tine Integrated Cultivator/Sifter 100 is operated. In various embodiments, Integrated Perforated Screen 110 comprises a mesh with an arrangement of evenly spaced and/or uniform openings. However, in various embodiments, Integrated Perforated Screen 110 comprises a mesh with unevenly spaced and/or non-uniform openings. In one embodiment, Integrated Perforated Screen 110 comprises a mesh with large and/or small openings.

In another embodiment, Integrated Perforated Screen 110 may comprise a mesh made of suitable material of various thicknesses. In another embodiment, Integrated Perforated Screen 110 may comprise a mesh of numerous wires. In various embodiments, Integrated Perforated Screen 110 may comprise a mesh configuration of various shaped openings, including generally round, square, rectangle, triangle, and/or any other two-dimensional shape. In yet another embodiment, Integrated Perforated Screen 110 comprises multiple meshes laid on top of one another in varying configurations.

FIG. 2 shows a perspective of Three-Tine Integrated Cultivator/Sifter 200, having three Tines 205a-c in a modified “Y” shaped configuration, in accordance with one embodiment. In many respects Three-Tine Integrated Cultivator/Sifter 200 is similar to Two-Tine Integrated Cultivator/Sifter 100, and the discussions (above) of many aspects of Two-Tine Integrated Cultivator/Sifter 100 are similarly applicable to Three-Tine Integrated Cultivator/Sifter 200, including discussions of Tines 105a-b, Handle 115, and Integrated Perforated Screen 110. Furthermore, Three-Tine Integrated Cultivator/Sifter 200 may be similarly used and/or operated as discussed above. These duplicative aspects of Three-Tine Integrated Cultivator/Sifter 200 will not be re-discussed here.

However, three tine Three-Tine Integrated Cultivator/Sifter 200 differs from the embodiments discussed above in that Tines 105a-b are replaced with three Tines 205a, 205b, and 205c, but are laid out in a modified “Y” shaped configuration, in accordance with one embodiment.

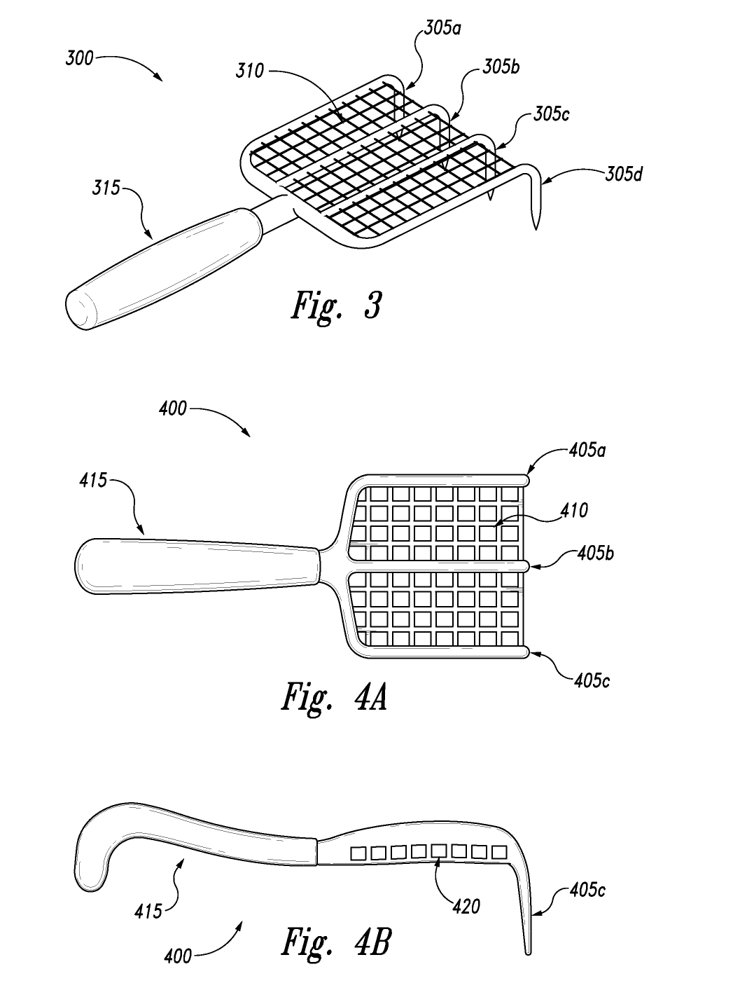

FIG. 3 is a perspective view of Four-Tine Integrated Cultivator/Sifter 300, having four Tines 305a-d laid out in a “square” shape configuration, in accordance with one embodiment. In many respects Four-Tine Integrated Cultivator/Sifter 300 is similar to Two-Tine Integrated Cultivator/Sifter 100 and Three-Tine Integrated Cultivator/Sifter 200, and the discussion (above) of many aspects of Integrated Cultivator/Sifters 100 and 200 are similarly applicable to Four-Tine Integrated Cultivator/Sifter 300, including discussions of Tines 105a-b, Handle 115, and Integrated Perforated Screen 110. Furthermore, Four-Tine Integrated Cultivator/Sifter 300 may be similarly used and/or operated as discussed above. These duplicative aspects of Four-Tine Integrated Cultivator/Sifter 300 will not be re-discussed here.

However, Four-Tine Integrated Cultivator/Sifter 300 differs from the embodiments discussed above in that Tines 105a-b and/or Tines 205a-c are replaced with four Tines 305a, 305b, 305c, and 305d that are laid out in a “square” shaped configuration, in accordance with one embodiment. Additionally, Integrated Perforated Screen 310 is configured to be in a “square” shape.

FIGS. 4a and 4b are top and side views, respectively, of Multi-Plane Integrated Cultivator/Sifter 400 with three tines in a “square” configuration, in accordance with one embodiment. In many respects Multi-Plane Integrated Cultivator/Sifter 400 is similar to Integrated Cultivator/Sifters 100, 200, and 300, and the discussions (above) of many aspects of these Integrated Cultivator/Sifters are similarly applicable to Multi-Plane Integrated Cultivator/Sifter 400, including discussions of Tines 105a-b, Handle 115, and Integrated Perforated Screen 110. Furthermore, Multi-Plane Integrated Cultivator/Sifter 400 may be similarly used and/or operated as discussed above. These duplicative aspects of Multi-Plane Integrated Cultivator/Sifter 400 will not be re-discussed here.

However, Multi-Plane Integrated Cultivator/Sifter 400 differs from the embodiments discussed above in that Tines 405a, 405b, and 405c are laid out in a “square” shaped configuration. Additionally, Integrated Perforated Screen 410 is configured to be in a “square” shape. Further, Handle 415 is ergonomically shaped as is discussed below.

Multi-Plane Integrated Cultivator/Sifter 400 also differ from Integrated Cultivator/Sifters 100, 200, and/or 300 in at least one fundamental design element, namely, that Multi-Plane Integrated Cultivator/Sifter 400 comprises the additional feature of Integrated Perforated Side Panels 420. However, Integrated Perforated Side Panels 420 are similar to Integrated Perforated Screens 110, 210, 310, and/or 410 in that it comprises a “mesh” made of suitable material and with similar properties as discussed above.

In various embodiments, Integrated Perforated Side Panels 420 operate in combination with the Integrated Perforated Screen 410, for ease of retaining and sifting scooped growing medium. In various embodiments, Integrated Perforated Side Panels 420 allow for greater capacity of growing medium to be captured and separated from unwanted material. In various embodiments, Integrated Perforated Side Panels 420 allow the user to oscillate the Multi-Plane Integrated Cultivator/Sifter 400 in a more vigorous manner resulting in more rapid separation of growing medium from unwanted materials and/or better retention of unwanted materials. In one embodiment, the combination of the Integrated Perforated Screen 410 and Integrated Perforated Side Panels 420 create a basket-type shape that allows for greater growing medium capacity. In alternative embodiments, the concavity of the Integrated Perforated Screen 410 and/or Integrated Perforated Side Panels 420 is increased to make a deeper basket-type shape.

FIG. 4b shows Handle 415 as an ergonomically designed handle. In various embodiments, Handle 415 is similar to Handles 115, 215, and/or 315 (discussed above) in that it is made of suitable materials (discussed above) to provide the user with a more comfortable gardening experience. In various embodiments, Handle 415 may comprise a design used to reduce the chances of injury to the hand and wrist from repetitive use of the Multi-Plane Integrated Cultivator/Sifter 400. The ergonomic shape of Handle 415 is not limited to the design or shape illustrated in FIG. 4b, and may be changed depending on the size and shape of a user's hands and/or wrists, and/or the type and quality of the growing medium to be prepared.

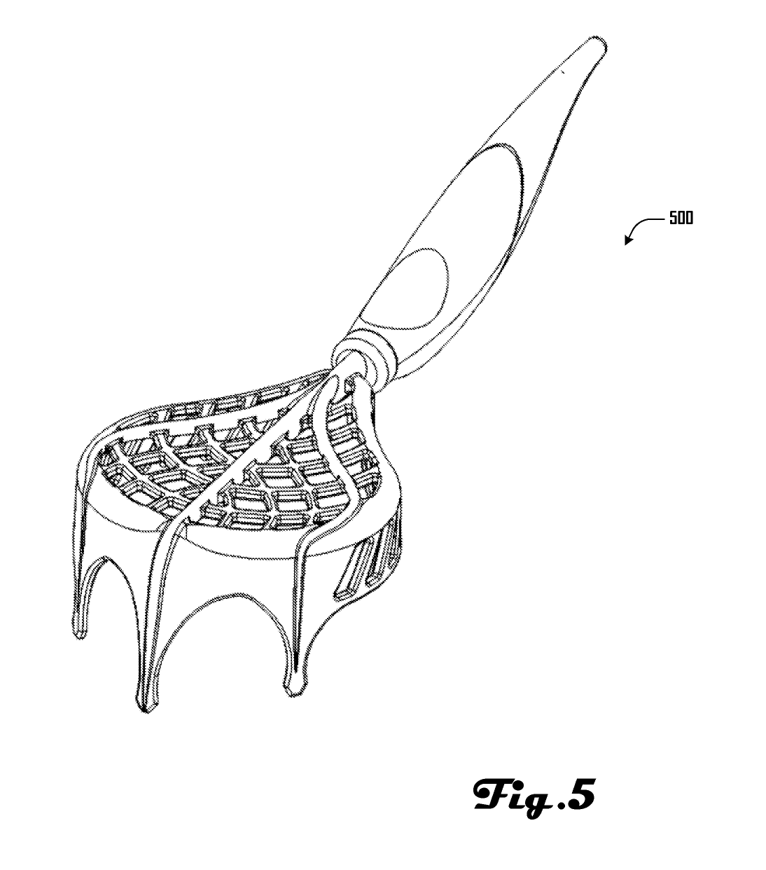

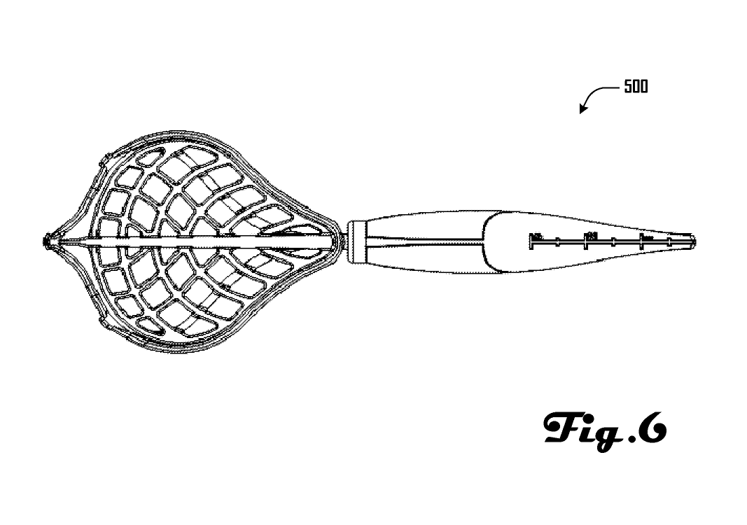

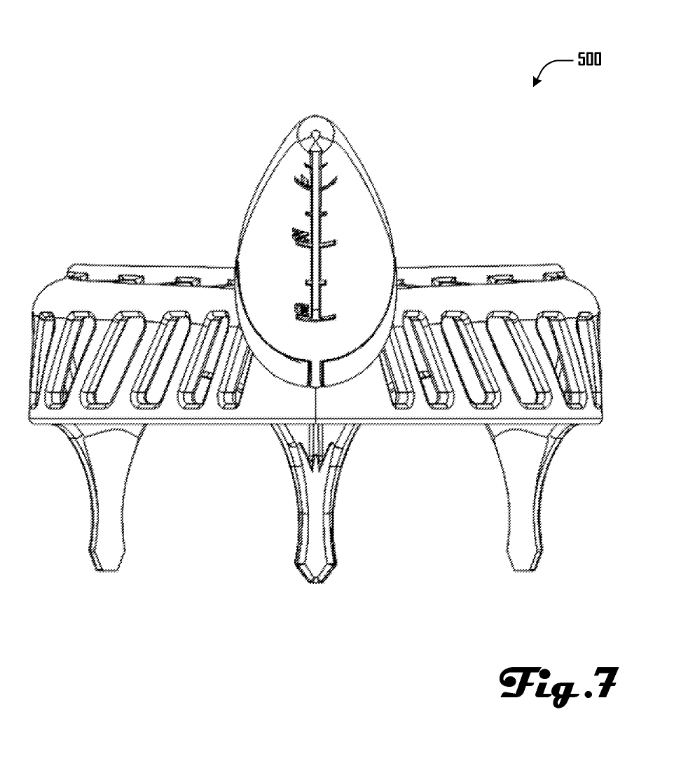

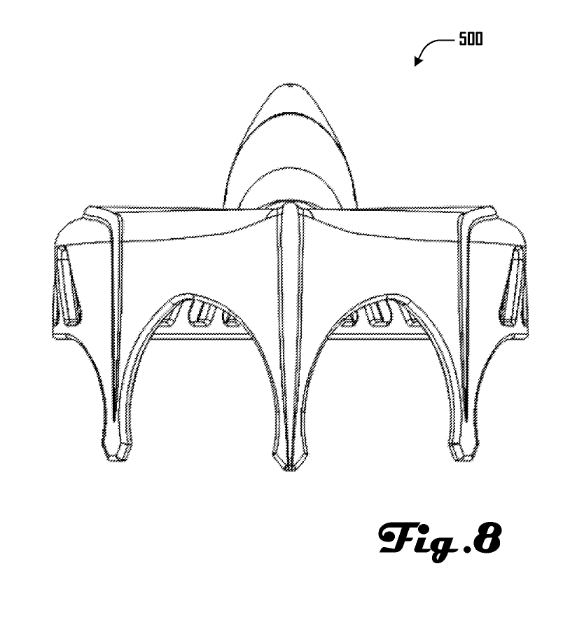

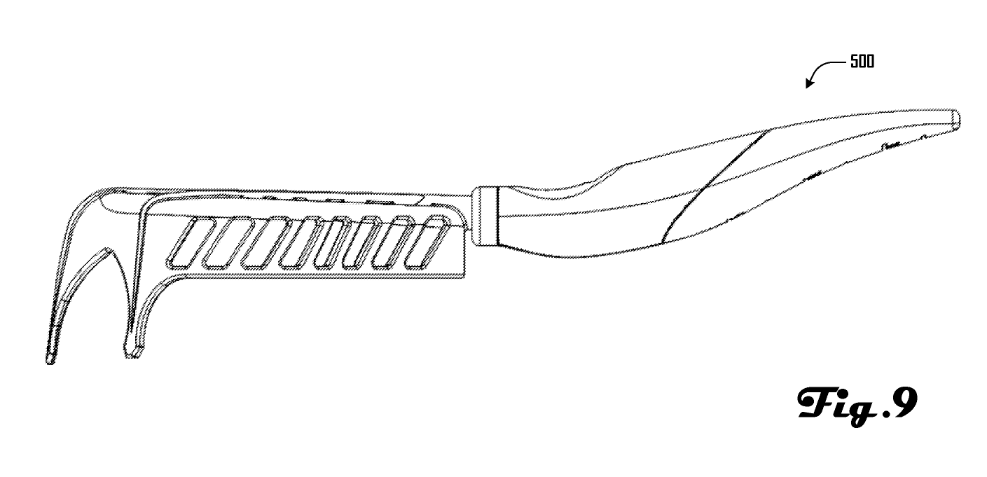

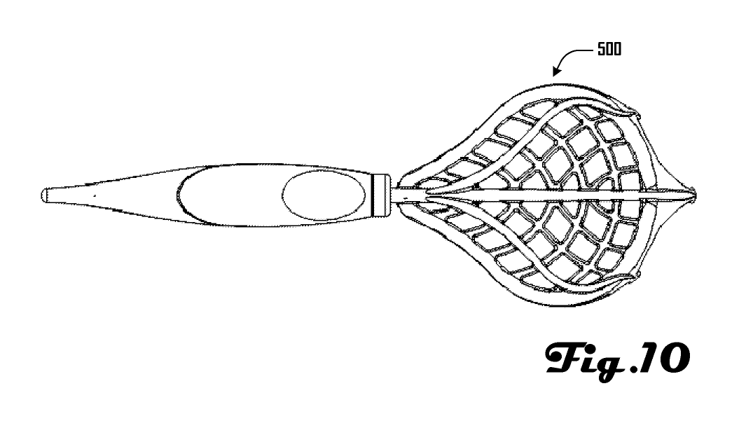

FIGS. 5-10 show various views of an Integrated Cultivator/Sifter 500 with three tines in a basket mesh “Y” configuration, in accordance with one embodiment. In many respects Integrated Cultivator/Sifter 500 is similar to Integrated Cultivator/Sifters 100, 200, 300, and 400, and the discussions (above) of many aspects of these Integrated Cultivator/Sifters are similarly applicable to Integrated Cultivator/Sifter 500, including discussions of Tines 105a-b, Handle 115, 415, and Integrated Perforated Screen 110, 410, and 420. Furthermore, Integrated Cultivator/Sifter 500 may be similarly used and/or operated as discussed above. These duplicative aspects of Integrated Cultivator/Sifter 500 will not be re-discussed here.

Although specific embodiments have been illustrated and described herein, it will be appreciated by those of ordinary skill in the art that alternate and/or equivalent implementations may be substituted for the specific embodiments shown and described without departing from the scope of the present disclosure. Further, it will be appreciated by those of ordinary skill in the art that alternate and/or equivalent configurations and/or shapes may be substituted for the specific embodiments shown and described without departing from the scope of the present disclosure. For example, although FIG. 4a-b shows Handle 415 that is attached to the Multi-Plane Integrated Cultivator/Sifter 400, in various embodiments, Multi-Plane Integrated Cultivator/Sifter 400 may employ a detachable handle. By way of another example, although FIGS. 1-4 show tines that have a cross section shape that is generally round, in various embodiments, Integrated Cultivator/Sifter may employ tines with a cross section of any suitable shape. This application is intended to cover any adaptations or variations of the embodiments discussed herein.

1. A hand-held integrated cultivator/sifting apparatus as shown and described.
